(19) United States
(12) Patent Application Publication
(10) Pub. No.: US 2007/0158607 A1
(43) Pub. Date: Jul. 12, 2007

(54) Method for determining the drive current for an actuator

(75) Inventors: Wolfgang Fey, Niedernhausen (DE); Mario Engelmann, Steinbach/Ts. (DE); Micha Heinz, Darmstadt (DE); Wolfgang Joeckel, Obertshausen (DE); Axel Schmitz, Hattersheim (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 10/566,782

(22) PCT Filed: Jul. 28, 2004
(86) PCT No.: PCT/EP04/51639

§ 371 Date: Jan. 31, 2006

(30) Foreign Application Priority Data
Jul. 31, 2003 (DE) 103586.3
Nov. 26, 2003 (DE) 103 55 836.5
May 13, 2004 (DE) 10 2004 024 058.2

(51) Int. Cl. F16K 31/02; H01H 47/00

(52) U.S. Cl. 251/129.16; 361/152

(57) ABSTRACT

Disclosed is a method for calibrating, mechanically adjusting, or calculating a drive current of an electromagnetically operable actuator. The actuator controls the flow of a fluid responsive to the differential pressure. The indicator of the influencing of the pressure caused by the actuator can be determined in advance by the intensity of the electric actuation of the actuator even without the use of pressure sensors, with one or more actuator-related characteristic curves, characteristic fields, or parameters KG_{ind} for the actuator being taken into account so that via these parameters a nominal flow G can be adjusted in a defined fashion in dependence on the current intensity I, and the actuator-related parameters are established automatically without using pressurizations of the actuator.

### BACKGROUND OF THE INVENTION

The present invention relates among others to a method for calculating a drive current by means of at least one electrically operable actuator, for example a solenoid valve, for controlling the flow G(ΔP, I, KG) of a fluid responsive to the differential pressure according a method for calibrating the drive current of the actuator. The method includes determining an indicator of an influence of a pressure caused by the actuator and automatically establishing actuator related parameters without using pressurizations of the actuator. Furthermore, the invention relates to an actuator having an electromagnetic coil and a tappet moved by an armature, and a measuring element used to determine a magnetic flux.

In addition, the invention relates to a method for measuring the pressure of a fluid including arranging a measuring element in the area of an actuator and controlling a drive of the actuator by using a measuring signal of the measuring element.

It is known in prior art to employ electromagnetically operable analogized valves for an improved control or for noise reduction in ABS control units for motor vehicle brake systems but also in co-called driving dynamics controllers equipped with additional functions such as ESP, etc.

So-called analogized pilot valves are used in up-to-date generations of hydraulic control units. An analogized pilot valve is a current-driven solenoid valve which is per se designed for complete opening or closing, however, is so operated by specific current adjustment that it has analog control properties.

EP 0 813 481 B1 (P 7565) discloses a method for the detection of the switch point of a pilot valve of analog operation, in particular for determining the pressure conditions from the current variation of the valve actuating current.

In principle, it is consequently possible to adjust the pressure gradient or flow G of a corresponding analogized pilot valve in dependence on the differential pressure by way of variation of the current through the magnet coil of the valve. However, the volume flow Q is difficult to adjust in the range of the control and depends, among others, on the differential pressure Δp and on the current I through the magnet coil of the valve. However, this dependency cannot be easily stored in a characteristic field once it is defined because even minor tolerances of the valve components which are induced by manufacture have a major effect on the functional interrelationship between flow and drive current. It is therefore necessary to determine a characteristic field for each individual valve during manufacture of the valves and to store it in a memory of the electronics of the control unit. To establish the individual characteristic fields, however, a complicated measuring method is necessary with defined pressurizations of the control units at the supplier's site or at the end of the assembly line at the site of the motor vehicle manufacturer. The characteristic fields determined by way of the sophisticated measuring method may then be used to adjust the desired pressure gradient, as has been described e.g. in WO 01/98124 A1 (P 9896).

DE 103 21 783.5 (P 10697) which is not published describes a learning method for valve characteristic curves of analog valves or analogized pilot valves. According to this method, a calibration of the hydraulic valves is performed during operation of the ABS brake device by using a learning method to determine an actuation characteristic curve or corresponding correction quantities for the correction of an existing actuation characteristic curve. It is characteristic of this learning method that is covers several cycles of the anti-lock control. The required pressure increase times are collected in each appropriate cycle, and the parameters found out by means of the current cycle are used to increase the characteristic curve according to a recursive formula. This method serves to improve an existing actuation characteristic curve, and therefore the precondition is that a characteristic curve already exists.

Hence, the methods for determining the characteristic fields or characteristic curves as described hereinabove either are not sufficiently precise, or they can only be carried out by a sophisticated measuring method at the supplier's site or at the end of the assembly line. It is only this way possible to determine the individual parameters KG_{ind} of a valve which influence the pressure variation and relate to manufacture, and which can be obtained e.g. from the measured characteristic fields or characteristic curves.

### SUMMARY OF THE INVENTION

In view of the above, an object of the invention is to disclose a method for determining parameters, valve characteristic curves or valve characteristic fields, which leads to a more precise actuation of the solenoid valves described above without requiring a sophisticated individual valve calibration during manufacture or at the end of the assembly line.

According to the invention, this object is achieved by a method for calibrating the drive current of the actuator. The method includes determining an indicator of an influence of a pressure caused by the actuator and automatically establishing actuator related parameters without using pressurizations of the actuator.

The term ‘actuators’ relates to valves and slides for the adjustment of fluid flow. Preferably, the actuator used is a valve. The fluid preferred is air or also any appropriate hydraulic fluid which is in particular a customary brake fluid in the application with a brake.

Favorably, the actuator has a completely opened and a completely closed position. Depending on the type of actuator, normally open (NO-V) or normally closed (NC-V), the valve adopts one of these position, in response to the action of a resetting element. An appropriate resetting element is preferred to be a spring which has a defined force/travel characteristic curve that can be approximated especially by a linear equation.

The method of the invention is advantageously implemented in an electrohydraulic device for the brake control for motor vehicles.

Preferably, the method of the invention also relates to a method for the adjustment or control of a pressure gradient of an actuator.

According to the method of the invention, the necessary characteristic curves or parameters or characteristic quantities are established for the calibration without using pressurizations of the actuator. This obviates the need for a separate pressurization during the establishment or the characteristic curves or parameters by means of a pneumatic or hydraulic measuring arrangement for determining the characteristic curves. Hence, the invention especially relates to a method for establishing particularly exact actuator characteristic curves or parameters during the operation of a motor vehicle, which is equipped with a brake system including in particular control valves for controlling the brake pressure.

The method of the invention, among others, achieves the advantage that a manufactured actuator or a complete hydraulic unit, unlike previously necessary, does not need being measured individually in a test bench by using defined pressures. According to the method of the invention it is sufficient that an electronic control which is connected to the actuator or to the hydraulic unit measures the electromechanical and magnetic properties of the actuator. Mainly, these properties are in particular those individual magnetic and mechanical parameters KG_{ind} of the actuator which are basically responsible for the deviation in the characteristic curve which is due to manufacture. Those parameters of the actuator which are less subject to deviations due to manufacture can be fixed once for the line of products by way of additional general parameters KG_{gen} and can durably be stored in the electronic control unit. The actuator characteristic curve and, thus, the necessary drive current for the actuator, being responsive to the differential pressure, can then be calculated from the parameters.

Further, the method of the invention is advantageous because the method, what is also preferably done according to the invention, can be implemented independently as frequently as desired, in particular in regular intervals even after the installation into a vehicle. This renders it possible that the system re-calibrates itself in regulator intervals. Hence, what is more, it is this way possible for the first time to take into account possible changes of the arrangement which are due to external influences, such as wear, and will not occur until a long time after the manufacture of the actuator. Consequently, the characteristic curves can be determined automatically without a measuring device by using the controller, even at a point of time after the installation into a vehicle. This condition favorably omits an additional data transmission step of an otherwise necessary measuring arrangement for determining the characteristic curves in the control unit.

As is generally the case, it is necessary for adjusting a defined flow G with the determined characteristic curves that the electronic controller additionally knows about the pressure difference ΔP at the valve. Said pressure difference is model-based calculated in approximation or measured by sensors according to the method, preferably in a per se known fashion. If, for example, only one pressure sensor exists in the area of the tandem master cylinder, the differential pressure is determined in particular from the time variation of the quantities influencing the pressure such as pressure increase times, etc. The accuracy of the flow is of great significance especially in this integrating method for determining the pressure gradient.

As has already been stated in a general fashion, it has been found out that the causes for the remaining deviations of the characteristic curves, or their gradients in particular, predominantly originate from the tolerances of mechanics, e.g. the changing spring force F_{spring} and the magnetic field circuit (e.g. magnetic resistances of the air slots, etc.) of the actuator.

According to a favorable embodiment of the method, the total magnetic resistance of the magnetic circuit is measured. It applies in general that instead of the magnetic resistance, it is also possible to use the inductance L of the corresponding magnetic circuit, related to the number of windings N of the coil, as an equivalent physical quantity in a corresponding manner for implementing the method of the invention.

Moreover, the invention relates to a valve which is equipped with one or more additional measuring elements, especially measuring coils.

The measuring coil can be electrically independent of the drive coil. It is, however, feasible according to a preferred embodiment to connect the measuring coil electrically in series with the drive coil. This is advantageous because only three actuating lines must be led to the outside.

In addition, the invention relates to a method for controlling the opening position and/or the flow through an actuator, in particular a valve.

The flow G of the actuator or valve, apart from the differential pressure and the geometric flow properties, is principally defined by the force which acts on the tappet of the respective actuator (tappet force). Therefore, the invention favorably also relates to a method for adjusting or controlling the tappet force of an actuator.

A measuring element, which is arranged in the area of the actuator according to another embodiment of the invention, renders it possible to determine internal physical parameters of the actuator and to take them into account when calculating the characteristic curves. This fact allows adjusting or controlling the tappet position, the tappet force, or the flow through the actuator in a particularly precise manner by way of the control described hereinabove.

Preferably, all magnetic-field-responsive sensors (such as Hall sensors, MR sensors) can principally be used as a measuring element beside the coil, provided they are suitable to sense the effective magnetic flux. The use of a coil appears, however, especially expedient due to the possibility of its low-cost manufacture.

According to the method of the invention, the spring force and if necessary the maximum tappet stroke, is preferably determined in a calibration routine. These quantities will then be included in the calculation of force.

A special feature of the method of the invention among others resides in that preferably the magnetic flux is measured, and the control is carried out according thereto in particular. This is suitable because the magnetic force depends directly on the magnetic flux. In this respect, there is a major difference compared to previously known methods in which the current through the coils is the predominant quantity.

The method described is used to preferably measure the maximum tappet stroke within the actuator and especially the spring force. The force-travel characteristic curve of the actuator may then be defined very accurately by additionally taking into account the known pressure gradient so that the flow through the valve can be regulated or controlled with a particularly high rate of precision.

Apart from the above provisions, the invention further relates to implementing the method of the invention for checking or improving the manufacturing quality of an actuator, in particular a valve, with the tappet stroke and/or the spring force being measured during or directly after the manufacture of the actuator or valve or the manufacture of the hydraulic valve block.

In another advantageous embodiment of the method described in the preceding paragraph, an additional mechanical adjustment of the actuator is carried out during the manufacture in addition to the electric calibration described hereinabove.

As this occurs, the residual air slot and the tappet stroke are adjusted especially during the assembly of the actuator alone by way of considering an electric parameter of the actuator. This is carried out in an especially preferred manner in that the magnetic resistance is measured when the actuator is closed and the magnetic resistance is measured when the actuator is opened.

Following this process of adjustment may be at a later point of time, preferably in addition, the electric pressureless calibration method described hereinabove. When performing the pressureless calibration method with pre-adjusted actuator, it is generally only necessary that the method compensates for a tolerance in the characteristics of the resetting spring.

The invention not only relates to a calibration method but also to a method for pressure determination wherein the pressure in a hydraulic fluid is measured from the force that acts on the valve tappet. The general principle of the tappet force control which is the basis of the invention is utilized in this method of pressure measurement.

Another improvement of the method of the invention is favorably achieved in that the above-mentioned learning method, as disclosed in DE 103 21 783.5, is additionally performed subsequent to the calibration of the invention.

According to another independent embodiment of the method of the invention, the measurement of the integral at the coil tap or at the tap of the measuring coil is performed by means of a so-called electronic square-wave forming circuit scheme which has a particularly straightforward design. This method concerns determining the magnetic flux in at least one inductive actuator, or in general an actor component, which can be actuated electrically by means of a driver by way of evaluation or adjustment of the voltage U_{ind} induced by actuator or actor component by using the measuring device, and the voltage applied to the inductive actuator or actor component is maintained at a substantially constant value actively by the measuring device or by the electronic actuation of the inductive actuator or actor component, and the time t₁ is determined during which the current flowing through the inductive component and the measuring device induces a voltage upon activation or deactivation.

Preferably the deactivation time t_{c} which indicates the time between the activation t₀ and the time t₁, or the activation time of the actor component is determined in this independent method.

In connection with the method described hereinabove, the invention further relates to an electronic circuit arrangement for determining the magnetic flux or the inductance of an inductive actuator or actor component, comprising a measuring device with signal Input and signal output, wherein the signal input is electrically connected to the inductive component and the output provides an electric signal comprising information about the time required to completely carry off the energy stored in the inductive actuator or actor component, with the voltage being constant, or to bring the current in the inductive actuator or actor component completely to the desired maximum current.

It is preferred in the circuit arrangement described above that the signal output of the measuring device is sent as an actual value to a control circuit, the controlled variable of which is the current through the inductive component.

The above-mentioned measuring method and the circuit arrangement is suitably employed for the measurement of the integrated voltage signal at the tap of the coil of the actuator in the calibration method described in the commencement in lieu of the measuring device.

### BRIEF DESCRIPTION OF THE DRAWINGS

Further preferred embodiments can be seen in the subsequent description of embodiments by way of Figures.

In the drawings:

FIG. 1 is a schematic view of a control circuit for controlling the magnetic flux without additional measuring coil;

FIG. 2 is an embodiment of a magnetic flux control with a measuring coil;

FIG. 3 is a cross-sectional view of a normally open analog/digital valve (NO-AD valve);

FIG. 4 shows an embodiment with measuring coil similar to FIG. 2, with the difference that the magnetic resistance is used as a controlled variable;

FIG. 5 shows an example for determining the magnetic resistance, with the valve closed;

FIG. 6 shows an example of a method for determining the magnetic resistance in an EBS control unit;

FIG. 7 shows an example for a method for determining the spring force of a solenoid valve;

FIG. 8 is a schematic view of a method for determining a valve opening current characteristic curve;

FIG. 9 shows an arrangement of a control circuit for the valve calibration with a square-wave forming circuit scheme.

### DETAILED DESCRIPTION OF THE DRAWINGS

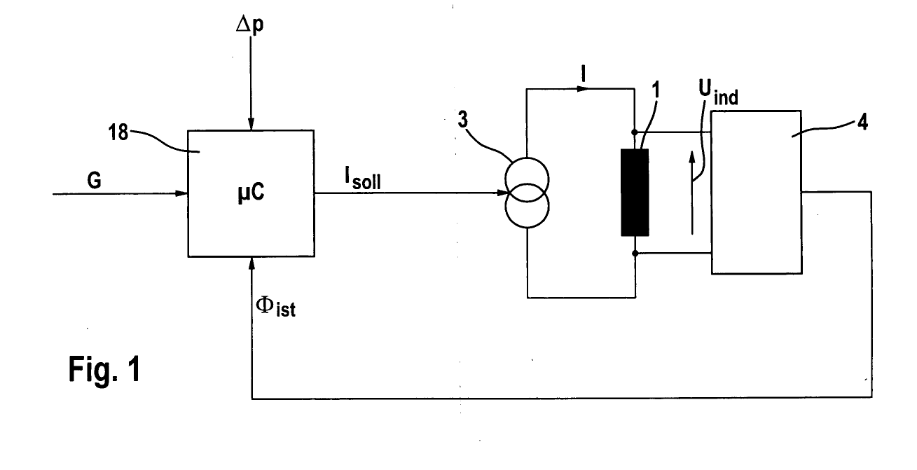

The subsequently described examples are employed in an electrohydraulic control device for passenger motor vehicle brakes. Typically, corresponding control devices (EBS control unit) comprise a controller housing (ECU) with a microcontroller system 18, as represented in FIGS. 1, 2 and 4, and a valve block (HCU) connected to the controller and comprising the electromagnetically operated valves 1 employed for the control of the hydraulic flux. Besides, the controller comprises a drive circuit (current source 3) enabling the valve current I to be adjusted and also measured in a pulse-width-modulated fashion for each individual valve. In the motor vehicle control unit (not shown herein), each valve includes corresponding valve drivers being realized by means of individually actuatable PWM drivers. A measuring device 4 is provided at the terminals of the coils and used to measure the induction voltage U_{ind}. A signal Φ_{actual} is provided at the output of measuring device 4 which is proportional to the integral of U_{ind}(t)

For the further explanation of the invention it appears appropriate to indicate the following mathematical interrelationships:

The magnetic force is obtained from

$${F}_{magn} = \frac{1}{2 * {μ}_{0} * {A}_{Armature}} * {Φ}^{2} ,$$

where μ₀ is the permeability constant (air), Aₐᵣₘₐₜᵤᵣₑ is the armature surface and Φ the magnetic flux.

The magnetic flux is calculated according to the formula

$$Φ = \frac{Θ}{{RM}_{total}} with Θ = I * N ,$$

where I is the coil current, N is the number of windings of the valve coil, and RMₜₒₜₐₗ is the total magnetic resistance of the magnetic circuit in the valve.

Further applies:

$${U}_{ind} = - N * \frac{ⅆ Φ}{ⅆ t} and Φ - \frac{1}{N} {\int }_{0}^{t} {U}_{ind} ⅆ t .$$

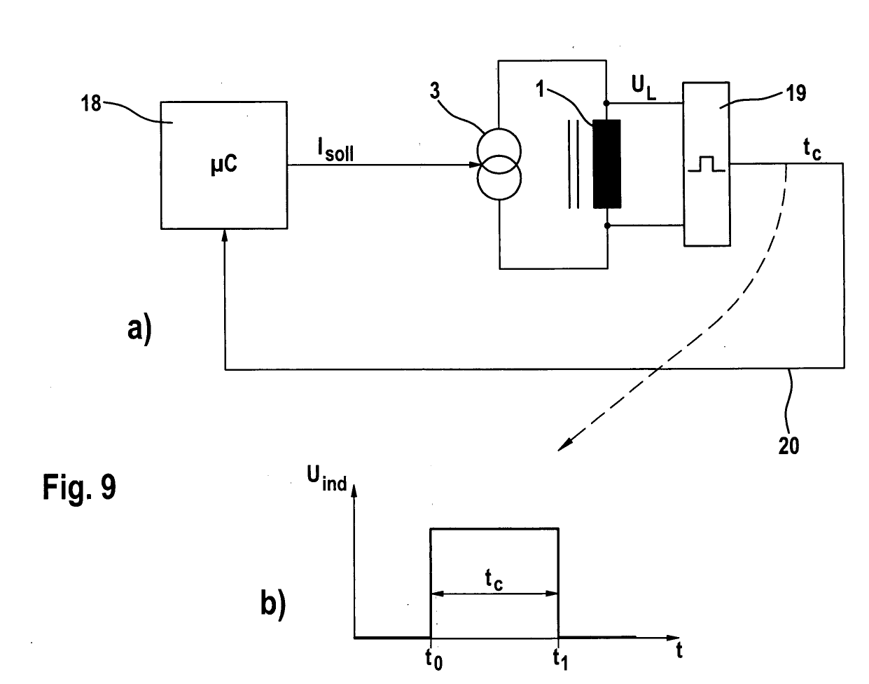

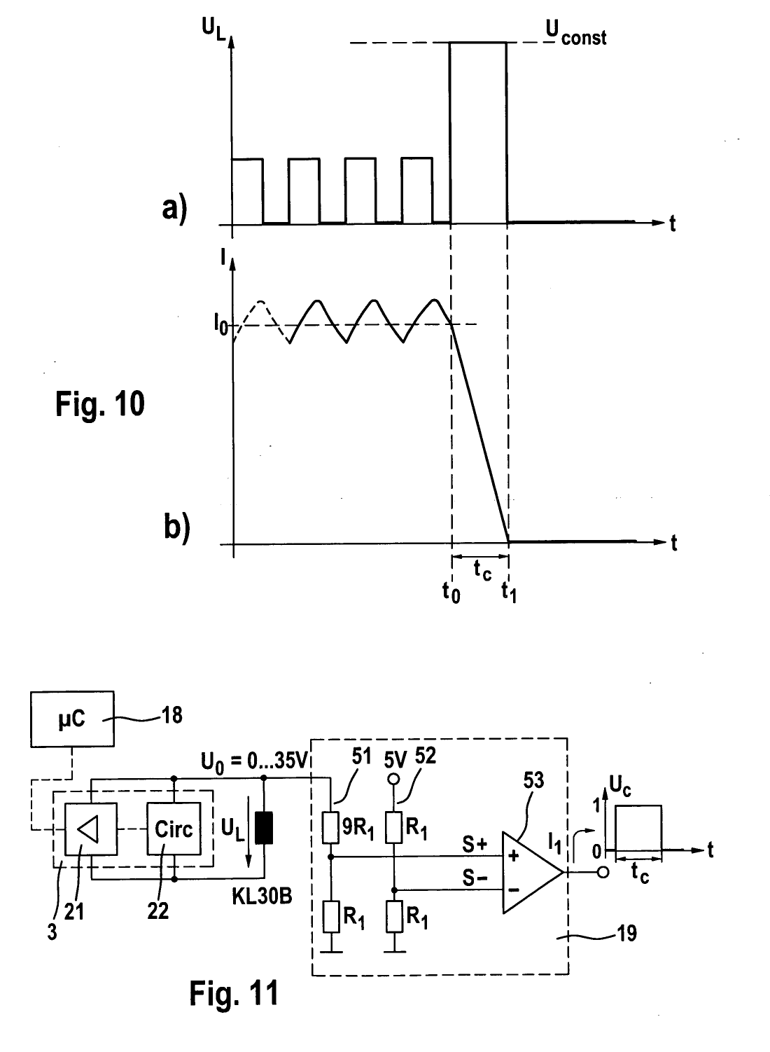

When the valve current I in FIG. 1 is disabled, the result is a change of the magnetic flux Φ in valve 1 which can be measured by the measuring device 4 connected to valve 1 by way of induction voltage U_{ind}. Measuring device 4 forms the integral of time concerning the variation of the induced voltage U_{ind} and leads the integrated signal to the microcontroller 18. This signal is proportional to the magnetic flux Φ induced by the valve coil. An alternative measuring device for determining this integral is described hereinbelow in connection to FIG. 9.

The feedback of the signal of the measuring device into the microcontroller consequently allows realizing flux regulation or flux control. The valve current flowing through the valve coil forms the actual correcting variable of the control.

The regulation or control of the magnetic flux is used to compensate the existing individual manufacturing tolerances (spring constant and air slots in the magnetic circuit) of the valve. The pressure gradient G to be adjusted is predefined by the ABS/ESP-control within the arithmetic unit μC (EBS-control unit). The differential pressure is known to the arithmetic unit. Depending on the equipment of the brake control unit, this pressure is defined completely by sensors or partly by way of a pressure model in a per se known manner. The spring force, the maximum tappet stroke, and the dependency of the magnetic flux on the valve current are established once or at different points of time corresponding to the measuring routine described hereinbelow (recalibration). Thus, all acting forces and the calculated force/travel function of the valve tappet are known; it is possible to calculate the valve current necessary for the demanded pressure gradient.

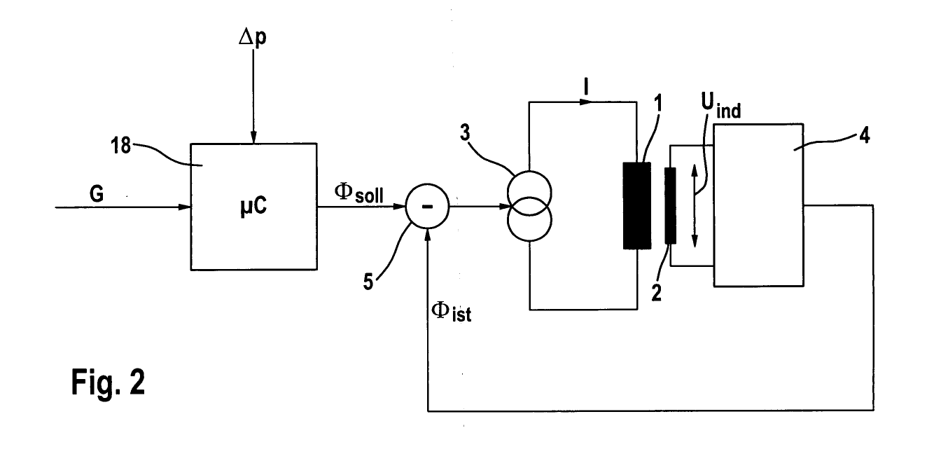

FIG. 2 presents another possibility of realizing the invention by way of an additional coil control circuit. The demanded pressure gradient G likewise prevails in the arithmetic unit (μC). The differential pressure is known to the arithmetic unit. The spring force and the maximum tappet stroke are determined by way of the measuring routine described hereinbelow. The magnetic flux is sensed by means of a measuring coil 2. The measuring coil is so arranged that it senses the effective magnetic flux through yoke and armature. When enabling and disabling the valve coil, a voltage U_{ind} is induced in the measuring coil whose integral is proportional to the prevailing magnetic flux. The signal Φ_{actual}, which is derived from the integral value generated by stage 4, is combined with the signal Φₙₒₘᵢₙₐₗ in the differentiator 5, forming the nominal quantity for the valve driver 3.

As has been mentioned before, the measuring routine for determining the valve-related parameters can be repeated any time (re-calibration) even during operation of the vehicle, for example, in order to compensate for changes or wear of the mechanic or also electric components, which are due to operation. The electronic actuation control will increase the coil current by way of the driver 3 until the magnetic flux in the magnetic circuit corresponds to the calculated flux. This means that the example illustrated in FIG. 2 concerns a tappet force control, where the tappet position depends on the pressure conditions at the valve.

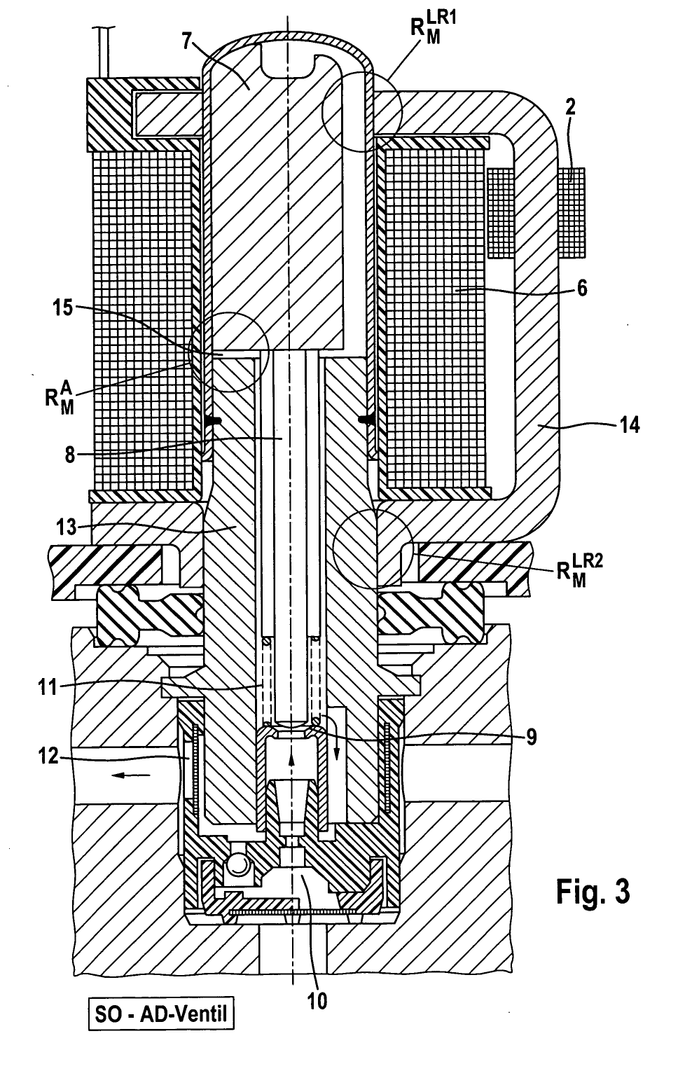

FIG. 3 shows the design of a solenoid valve that can be inserted into an ABS/ESP valve block according to the invention. The valve according to the examples related to the invention is a normally open valve which is operated in a per se known fashion controlled by means of a PWM-controlled current. Corresponding valves are known and termed as analogized digital valves ‘AD valve’. Subsequently, the design of such a NO AD valve, especially the components of the magnetic circuit leading the lines of electric flux, will be described in detail. The energized valve coil 6 serves for moving the armature 7 axially guided in the valve housing 13 and engaging the valve seat 9 in a sealing manner by way of tappet 8. Hydraulic fluid flows through valve inlet 10 to the valve seat 9 and escapes through outlet 12. Spring 11 pushes tappet and armature into the opened position, in the absence of current flowing through coil 6. With the coil 6 energized, the lines of magnetic flux penetrate yoke 14 and enter the housing 13. The point of transition between yoke 14 and housing 13 forms the magnetic resistance RM^{LR2}. In the further course, the lines of electric flux penetrate the air slot 15 between armature 7 and housing 13, and the magnetic resistance prevailing at this location is referred to as RM^{A}. Another air slot develops between armature 7 and yoke 14, allocated to which is the magnetic resistance RM^{LR1}.

Hence follows that the magnetic resistance of the magnetic circuit is basically determined by the sum RMₜₒₜₐₗ=RM^{LR2}+RM^{A}+RM^{LR1}. One may already see in this respect that the magnetic resistance mainly depends on the magnitude of the manufacture-related air slots and on the tappet position. It is thus possible to imagine the magnetic resistance as the sum of the measured magnetic resistance in the closed state of RMᵥₐₗᵥₑ and the magnetic resistance of the air slot RMₐᵢᵣ:
RMₜₒₜₐₗ=RMᵥₐₗᵥₑ+RMₐᵢᵣ.
The quantity RMᵥₐₗᵥₑ can be measured in the closed state, and quantity RMₐᵢᵣ is achieved from the formula

$${RM}_{air} = \frac{l}{{μ}_{0} * {A}_{armature}} ,$$

where

Aₐᵣₘₐₜᵤᵣₑ represents the magnetically active surface of the armature 7 that is specific for the line of products of the valves (parameter KG_{gen} related to the line of products), and 1 represents the tappet stroke. The actual measuring method does not measure the value for RMₐᵢᵣ directly, but by way of measuring the magnetic resistance with the valve completely opened and by subtracting the magnetic resistance of the closed valve. This way the tappet stroke 1 can also be determined.

FIG. 3 also illustrates the measuring coil 2 which is necessary for executing the embodiment described in FIG. 2 and is positioned in the area of the yoke 14.

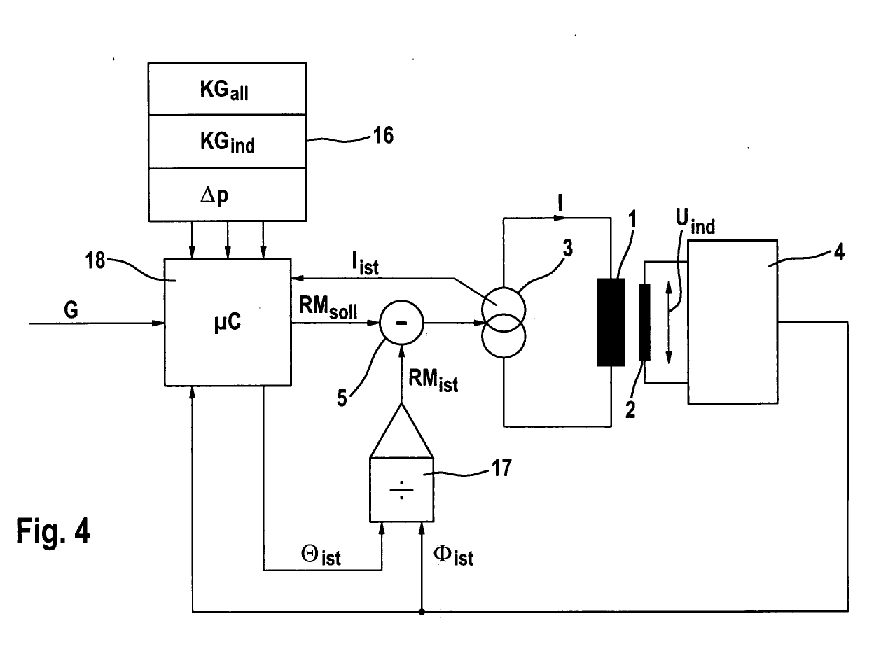

FIG. 4 represents another example for a control circuit where the tappet position 1 is directly controlled. As has been stated already, the magnetic resistance RMₜₒₜₐₗ is composed of the magnetic resistance of the closed valve and the magnetic resistance of the air slot. The magnetic resistance of the closed valve can be defined by a one-time measuring routine. RMₜₒₜₐₗ is the quotient of Θ(=I*N) and the magnetic flux Θ. The quantity RMₐᵢᵣ is obtained from the tappet stroke divided by μ₀*A(μ₀=permeability constant, A=cross-sectional surface). It further applies that RM_{actual}^{total}=.

$$\frac{{Θ}_{actual}}{{Φ}_{actual}} .$$

This quantity is calculated by divider 17. The output of divider 17 is connected to the differential element. The quantity Θ_{actual} is dictated by way of the voltage variation that is determined at the measuring coil and temporally integrated by means of integration stage 4. This quantity is proportional to the differential pressure. As RMₜₒₜₐₗ is proportional to the tappet stroke, the illustrated control of RMₜₒₜₐₗ leads to a direct control of the tappet stroke 1. In this arrangement, the arithmetic unit μC converts the demanded pressure gradient into a specific flow cross-section or tappet stroke and, thus, into a nominal magnetic resistance RMₙₒₘᵢₙₐₗ. The basis for the calculation are per se known hydrodynamic parameters KG_{general} which hold true for the overall line of products of valves and, therefore, can be fixedly stored in the arithmetic unit μC, as well as valve-related parameters KG_{ind}, which are individually defined by the method likewise described herein. These valve-specific parameters are e.g. the total magnetic resistance of the closed valve and the spring force (see block 16). The current differential pressure is likewise required for the control, as has been described hereinabove. Additionally the present valve current is determined and multiplied by the number of windings of the exciter coil. The product is the magnetic flux Θ (magnetomotive force). The present magnetomotive force is divided by the present magnetic flux. The result is the present magnetic resistance. A comparison between nominal and actual values is performed for control purposes, and the correcting variable I (coil current) is generated therefrom.

The method according to the example in FIG. 4 additionally renders it possible to determine, without additional pressure sensors, the pressure in the fluid lines connected to the valve in the individual pressure sensors. With a constant tappet position which must be maintained constant by a controller, the pressure can be calculated similarly to the above-described method from the tappet force currently measured in this tappet position in conjunction with the known general parameters KG_{general} of the valve.

In a motor vehicle brake system, the inlet pressure is e.g. determined by the brake pedal application. As is known, the inlet pressure e.g. deviates during an ABS control operation from the pressure in the individual hydraulic lines leading to the brake cylinders. As only the differential pressure prevailing at the valve is principally determinable according to the preceding measuring method, it may be necessary to define the pilot pressure by way of sensors (e.g. pressure sensor at the tandem master cylinder). It is, however, also possible to determine the pilot pressure mathematically by considering models. It is also feasible to determine the pressure even without exact knowledge of the pilot pressure by taking defined operating conditions of the brake system into consideration. This way pressure can be determined without any pressure sensors. The result is economy of considerable costs for additional pressure sensors in an ABS/ESP brake control unit.

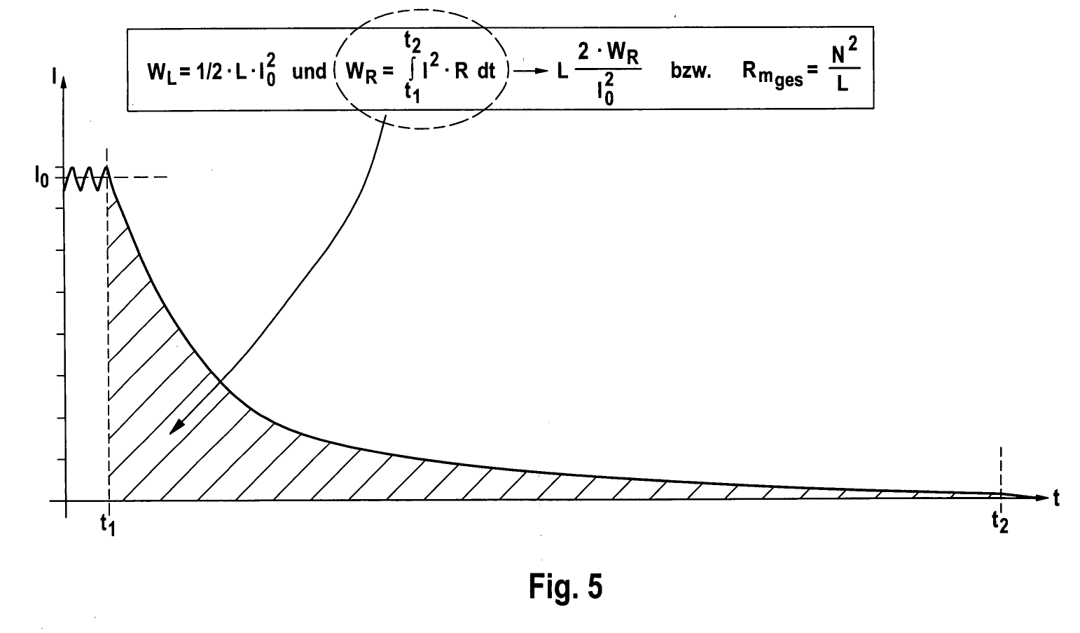

The diagram in FIG. 5 shows the current variation in a valve coil after disabling the current, with a valve closed. The integral below the current curve allows determining the magnetic resistance RMₜₒₜₐₗ, with a known number of coil windings N. The physical interrelationship can be taken from the formulas indicated in the box in FIG. 5, where W_{L} represents the magnetic energy of the magnetic circuit and R is the ohmic resistance of the electric coil circuit.

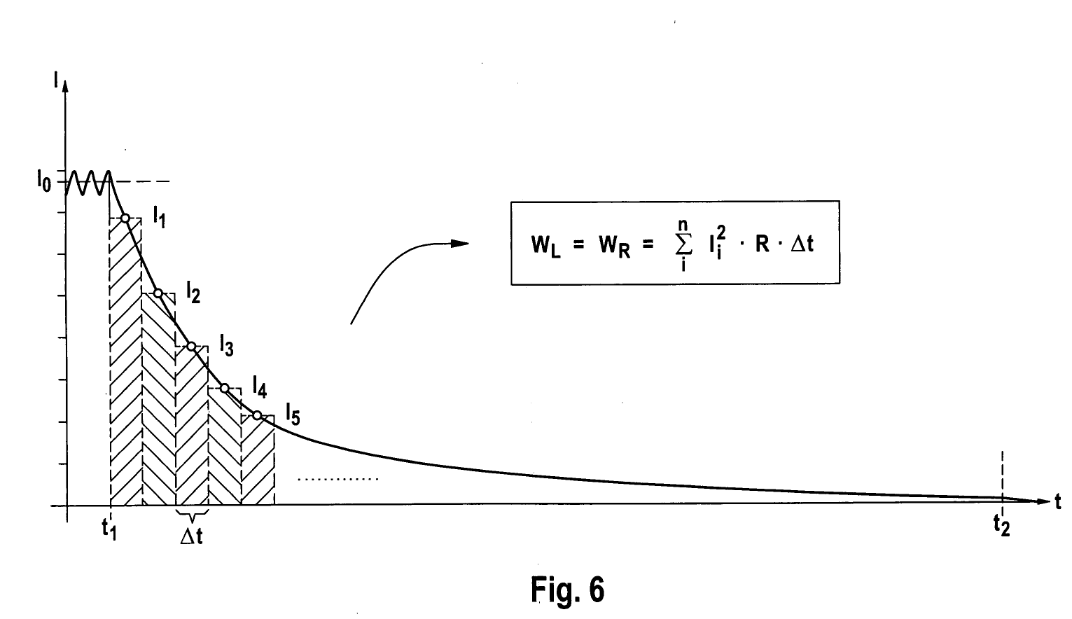

FIG. 6 depicts an example for performing a measuring method to determine the magnetic resistance corresponding to the principle in FIG. 5. A current value I₀ is adjusted in a first step by means of the EBS control unit (controlled), with the valve reliably closed. Subsequently, the duty cycle of the PWM control is set in such a fashion that no more current is fed into the coil driver. The current stored by the inductance decays due to the recirculation possibility of the final stage. Thereafter follows a measurement of the current variation at predefined points of time in the same distance

(I₁, I₂, I₃, . . . ) in the period t₁ to t₂. The measured current values are stored by the software in the control unit. The formula indicated in the box in FIG. 6 shows a possibility of forming the integral W_{L} of a sum.

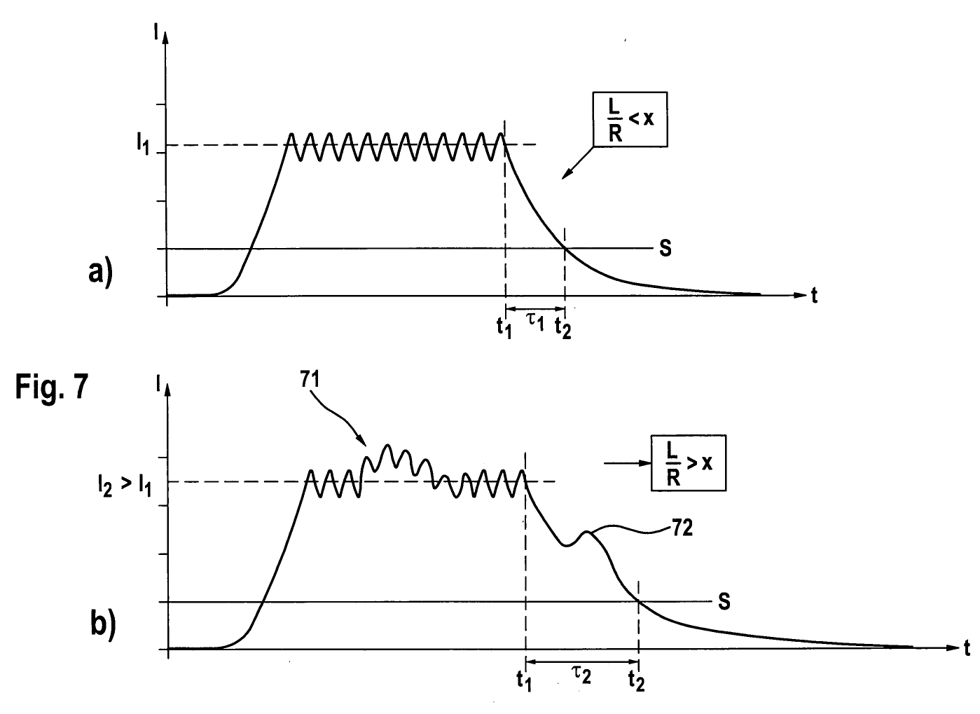

According to the method outlined in FIG. 7, initially the current is successively increased in steps, commencing with an appropriately low current of e.g. I≈0. In partial image a) the current is initially maintained at a value I₁, at which the valve is just still open, i.e. the valve would close at a higher current. The current is disabled at time t₁, and the time τ₁ is measured until the present current value has dropped below a threshold value S (time t₂). The opened position of the valve results in a low inductance and, thus, a short time constant τ₁ with an exponential current decay behavior.

Partial image b) shows the current variation when the corresponding valve is driven by a current I₂ which causes the valve to close. The closing action can be identified at a short-time elevation 71 of the current in the constant current range. The current is disabled in time t₁ as mentioned above, the current decays once more until below the threshold S. In contrast to the open valve, however, the time constant τ₂ of the initially closed valve is higher in partial image b) due to the lower magnetic resistance (higher inductance) than the corresponding time constant in partial image a). In addition, opening of the valve which can also be identified at an elevation 72 in the current variation also causes an extension of the time constant.

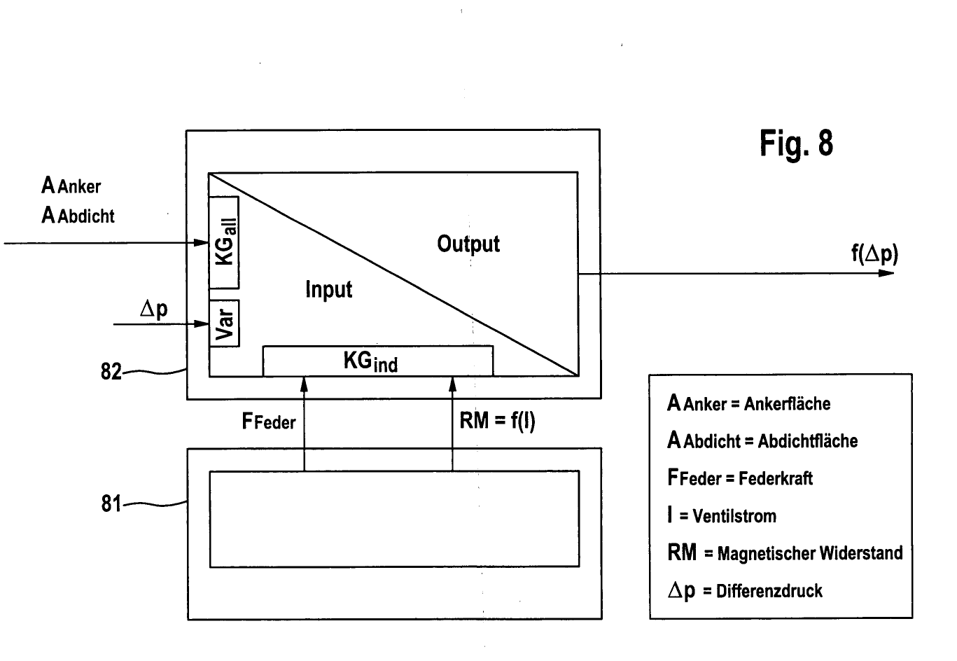

FIG. 8 represents an example for an algorithm 82 to calculate the valve opening current characteristic curve by means of the valve-related individual parameters KG_{ind} (measuring method 81) determined according to the examples in FIG. 5 to 7 in an electrohydraulic control device 82. The valve-related individual parameters KG_{ind} may generally concern characteristic curves or parameters of the valve. In an electronic brake control unit with ABS function and, as the case may be, additional functions such as TCS, ESP, etc., a curve is required for valve control with high precision which indicates the current necessary to open the valve at a predetermined differential pressure ΔP (differential-pressure-dependent valve opening current characteristic curve f(ΔP)). Predetermined for algorithm 82 are universal parameters KG_{general} being stored at the input end in the controller and characterizing the valve series. The parameters can be designated in detail by the armature surface Aₐᵣₘₐₜᵤᵣₑ related to the line of products and the valve sealing surface A_{sealing}. Further, the current differential pressure ΔP for the respective valve is predefined at the input as a variable quantity (Var) which is either determined by sensors or calculated in approximation from other quantities by means of the EBS system.

Initially, the hydraulic force F_{hydraulics} is calculated by way of F_{hydraulics}=ΔP*A_{sealing} corresponding to algorithm 82 according to the sealing cross-section A_{sealing} (universal valve parameter KG_{general}) defined in the controller. Based on the predetermined armature surface Aₐᵣₘₐₜᵤᵣₑ and the magnetic resistance RM, the current-responsive magnetic force F_{magn}(I) can be calculated. In the equilibrium condition the valve is still closed at just the moment. The magnetic force F_{magn}, which is necessary for this purpose, achieves the holding current:
F_{spring}+F_{hydraulics}=F_{magn}

Consequently, this formula allows calculating the differential-pressure-dependent holding current for discreet differential pressures (no volume flow in the valve) with relative precision in consideration of the valve sealing surface and the sealing cross-section.

It is furthermore suitable for application in an EBS system to additionally perform the subsequently described correction measures A) to C) in order to further increase the accuracy of the determined holding currents:

A) Opening Current/Holding Current Correction

The so-called holding currents which are determined on the basis of the balance equation F_{spring}+F_{hydraulics}=F_{magn} at a defined pressure difference do not yet correspond to the opening currents actually required to open the valve, as they are always somewhat lower than the calculated holding currents, which is due to flow effects. It has shown that the more accurate opening current characteristic curve I_{opening}(ΔP) can preferably be determined in that a constant negative current offset I_{corr}^{const} is added in the required pressure difference range of the holding current characteristic curve I_{holding}(ΔP). The current offset can easily be determined by appropriate tests:
I_{opening}(ΔP)=I_{holding}(ΔP)−I_{corr}^{const}
B) Magnetic Correction

The calculation of the holding current characteristic curve as described hereinabove is based on the simplified assumption that the magnetic resistance, when the valve is closed, does not depend on the current. Due to the influence of the ferromagnetic materials existing in the magnetic circuit of the valve, however, a correction term is still suitable in order to further augment the precision, which term allows correcting the influence of the ‘iron circuit’. To correct this influence, a linear equation, especially in first approximation, for the resistance variation of the magnetic resistance RM(I)=m*I+b is adopted for the closed valve. This curve can be defined by measuring RM at different currents I₁, I₂, Iₙ, and all Iₙ are higher than the closing current of the respective valve. A gradient of m in the range of

$${10}^{6} \frac{Vs}{I}$$

is achieved in the present example. Inserting the described correction term into the formula for calculating F_{magn} will then allow establishing a corrected holding current characteristic curve which is freed from the influence of the ferromagnetic materials to the greatest possible extent.
C) Thermal Correction

As can be taken from the formulas indicated in the box of FIG. 5, the magnetic resistance RMₜₒₜₐₗ is proportional to 1/R_{L}, where R_{L} is the coil resistance, when it is assumed for reasons of simplification that the resistance of the electric circuit is exclusively defined by the coil resistance. It has previously been assumed in the method described hereinabove that R_{L} is a parameter related to the line of products which needs not be taken into consideration. However, temperature changes of the coil, being due to the coil resistance, will take effect on the measured magnetic resistance, which is undesirable. A correction term which eliminates this influence will therefore lead to a method of calculation which is still further improved. Such a thermal correction of the measured magnetic resistance can preferably be brought about in that the coil resistance is defined by way of the duty cycle of the pulse-width-modulated valve actuation. WO 03/074338 A1 discloses a method appropriate for determining the coil resistance.

The above statements relate to a valve which is normally open. The method described may be used in a similar fashion also for valves which are normally closed.

The embodiment illustrated in FIG. 9a relates to a circuit arrangement as described in FIG. 1, with the difference that a square-wave former 19 as illustrated in FIG. 11 is provided for the simplified measurement of the induction voltage. Square-wave former 19 may also be employed in a favorable way in lieu of the measuring device 4 in FIG. 2. As has been described already hereinabove, the EBS controller comprises a driver circuit 3 (current source) which is used to adjust and also measure the valve current I individually for each valve in a pulse-width-modulated fashion. In conjunction with the square-wave former 19, the induction voltage U_{ind} can be measured in a simple manner by way of a measurement of time, as drafted in partial image b). The magnetic flux in coil 1 of the actuator induces a voltage U_{L} (terminal voltage) when the current is disabled at to so that the current drops to roughly the value 0 when disabled in a time t_{c}. The voltage variation of U_{L} is illustrated in more detail in FIG. 10a). FIG. 10b) shows the current variation which is meanwhile produced by the PWM valve actuation.

The quantities R_{L} (resistance of the coil), U_{L} (adjusted commutation voltage), as well as I₀ (valve current) are known to the arithmetic unit 18. The time t_{c} which is proportional to the inductance L, is sensed by means of the square-wave former 19. At the output of square-wave former 19, an electric signal prevails which is proportional to t_{c}. This signal is sent through line 20 to the arithmetic unit 18 as an actual quantity for the control operation being performed.

The mode of operation of the square-wave former 19 becomes apparent from the electronic circuit arrangement in FIG. 11. Current source 3 comprises a current driver 21 and a recirculation circuit 22 which controls the recirculation current by a controllable resistance after disabling of the current at time t₀, and recirculation circuit 22 is driven by the arithmetic unit 18. A corresponding circuit for driving hydraulic valves is already known from patent application DE 102004017239.0. Connected to terminal U₀ is a first voltage divider 51, composed of resistors R₁ und 9R₁, which reduces the high voltage values U₀ at the signal input S+ of the comparator 53 by approximately the factor 10. A second voltage divider 52 produces a reference voltage at the input S− of the comparator 53 which equals half the logic supply voltage. Comparator 53 thus evaluates the difference between the signals S+ and S−, with the result that an appropriate square-wave signal is produced.

By means of the recirculation circuit 22, the current can be commutated after disabling within a relatively short time (less than 1 ms), as is illustrated in FIG. 10b. As this occurs, the terminal voltage U_{L} can be adjusted to a constant value U_{const} (FIG. 10a). During a per se known pulse-width modulated control (PWM) of the valve current, the voltage at U₀ rises to a maximum of roughly 18 volt so that the input S+ will never exceed 2.5 volt. The output of the comparator thus stays on ‘logical 0’. At the commencement of a commutation in the sense of disabling, the voltage U₀ rises to e.g. 35 volt, with the result that S+, with 3.5 volt then, will be considerably higher than S−. The consequence is a change-over of the comparator to ‘logical 1’ until the voltage U₀ drops again to 0 volt corresponding to the end of the commutation in the sense of disabling. Thereafter, the comparator will also change over to ‘logical 0’ again. Thus, the duration of the ‘logical 1’ at the output of the comparator corresponds precisely to the duration t_{c} of the said commutation.

The inductance of the coil is calculated from the current variation during the commutation in the sense of disabling between time t₀ and time t₁ according to the formula:

$${u}_{L} = L \cdot \frac{ⅆ i}{ⅆ t}$$

Due to the special actuation, where U_{L} is kept constant between the time t₀ and t₁, the time integral of the current, which is to be calculated in order to determine the inductance of the coil, becomes very simple. The inductance of the valve coil may then be determined in a particularly simple fashion by way of

$$L = \frac{- {t}_{c} \cdot {R}_{L}}{ln ( \frac{{u}_{L}}{{I}_{0} \cdot R + {u}_{L}} )} .$$

1-21. (canceled)

22. A method for calibrating a drive current of at least one electrically operable actuator for controlling flow of a fluid responsive to a differential pressure, the method comprising:
determining in advance an indicator of an influence of a pressure caused by the actuator by an intensity of the electric actuation of the actuator, with one or more actuator-related characteristic curves, characteristic fields, or parameters for the actuator being taken into account so that a nominal flow can be adjusted in a defined fashion in dependence on the current intensity; and
automatically establishing the actuator-related parameters without using pressurizations of the actuator.

23. A method according to claim 22, wherein at least one of an opening travel or a spring force of the actuator is determined for the calculation of the actuator-related parameters.

24. A method according to claim 22, wherein general parameters, other than the actuator parameters, related to the line of products are taken into consideration for calculating the drive current.

25. A method according to claim 24, wherein the general parameters of the actuator, related to a line of products, are durably stored in a memory, and the stored parameters are transferred into the accumulator at or before the end of the assembly line.

26. A method according to claim 22, wherein a functional interrelationship of the flow G dependent on the drive current I is approximated according to the formula G=G₀+m*I, where the pressure gradient G₀ at a current of I=0 is determined by measuring at least one individual magnetic parameter, with the valve open or closed, and at least one parameter is determined by measuring the magnetic resistance, with the valve open and closed.

27. A method according to claim 22, wherein a tappet force or a magnetic resistance is determined as actuator-related parameters.

28. A method according to claim 27, wherein a position of the tappet is determined from the tappet force or the magnetic resistance.

29. A method according to claim 22, wherein a voltage induced at the drive coil as a consequence of a current variation is measured and more particularly integrated.

30. A method according to claim 22, wherein a flux or the magnetic resistance is controlled via a control loop.

31. A method according to claim 22, wherein at least one of a holding current or an opening current of the actuator is determined from the actuator-related parameters.

32. An actuator with at least one electromagnetically operable hydraulic valve, comprising:
an electromagnetic coil (6) and a tappet (8) moved by an armature (7), wherein the armature is moved, influenced by a current, to open or close the actuator; and
one or more additional measuring elements utilized to determine a magnetic flux.

33. An actuator according to claim 32, wherein the additional measuring element is a measuring coil (2).

34. An actuator according to claim 32, wherein the measuring element determines the magnetic flux of at least one actuator component.

35. A method for adjusting an opening position or the flow through an electrically drivable actuator, the actuator having an electromagnetic coil (6) and a tappet (8) moved by an armature, the method comprising:
arranging in the area of the actuator at least one measuring element, such as a measuring coil; and
controlling a drive of the actuator by using a measuring signal of the measuring element.

36. A method according to claim 35, wherein the measuring signal of the measuring element is a voltage.

37. A method according to claim 36 further comprising:
determining from the integrated voltage a magnetic flux; and
determining at least one of the magnetic force or the tappet stroke from the determined magnetic flux.

38. A method according to claim 35, wherein a valve opening current is corrected by a correction term which also takes into consideration a current-responsive influence of a ferromagnetic circuit.

39. A method according to claim 35, wherein initially a valve holding current is calculated, and a valve opening current is determined based on the valve holding current via an additional correction term or an offset.

40. A method according to claim 35, wherein the actuator is driven by a pulse-width modulated current, a coil resistance is determined by a duty cycle of the PWM actuation, and the coil resistance is also taken into account in the calculation of the parameters in each individual actuator.

41. A method for measuring the pressure of a fluid by an electromagnetically driven without utilizing additional pressure sensors, the method comprising:
controlling a tappet position by using an electric control circuit; and
calculating a pressure in the fluid line or a pressure difference in the actuator from a force that acts on the tappet, wherein the force can be measured electrically.
